(19) United States
(12) Patent Application Publication
(10) Pub. No.: US 2007/0165605 A1
(43) Pub. Date: Jul. 19, 2007

(54) Apparatus and method for handling call features activated by POTS phones in an IP multimedia subsystem

(75) Inventors: Hai Duong Nguyen, Plano, TX (US); Kevin Song, Carrollton, TX (US); Jeff Lin, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/333,034

(22) Filed: Jan. 17, 2006

(51) Int. Cl. H04L 12/66

(52) U.S. Cl. 370/352

(57) ABSTRACT

A SIP Gateway (SIPGW) coupled to an IP Multimedia Subsystem (IMS) is disclosed that detects when a first party, using a Plain Ordinary Telephone Service (POTS) telephone coupled to the SIPGW and participating in a call, performs a hook flash action. In response, the SIPGW sends to the IMS a first SIP INFO message indicating that the POTS telephone has performed the hook flash. In response to a first SIP INFO message indicating that a first party has performed a first hook flash, an Application Server (AS) in an IMS places on hold a second party participating in the call. The AS may also cause a Media Server to receive information from the first party identifying a call feature to be provided, where the call feature is one of simple call hold, consultation call hold, attended call transfer and unattended call transfer.

### TECHNICAL FIELD OF THE INVENTION

The present application relates generally to IP Multimedia Subsystems and, more specifically, to an IP Multimedia Subsystem providing call features activated by Plain Ordinary Telephone Service telephones.

### BACKGROUND OF THE INVENTION

Plain Ordinary Telephone Service (POTS) telephones are typically connected to a Class 5 Local Switch, owned by a Local Exchange Carrier (LEC). Such Local Switches are typically coupled to a Signal Transfer Point (STP), which may be coupled to other STPs. A Service Control Point (SCP) coupled to the STP provides call functions such as Call Waiting, Call Hold and Call Transfer. These call functions are invoked when the Local Switch detects a service request event in the POTS telephone and signals the SCP that the event has occurred.

The traditional telephone network structure is being replaced by a Next Generation Network (NGN), in which functionality is less centralized than in the traditional network. The NGN is designed on the assumption that NGN-capable telephones and other customer peripheral equipment have more processing power than POTS telephones and, therefore, are able to execute more of the signaling needed to perform call functions. However, this assumption creates the requirement that, in order to take advantage of NGN services, POTS telephones must be replaced with devices capable of communicating using the Session Initiation Protocol (SIP), such as so-called ‘soft phones’ and SIP phones. Such devices typically trigger call functions in the network and other SIP-capable devices by sending a SIP INVITE message.

In a parallel development, the Universal Mobile Telecommunication System (UMTS) was developed to provide services including telephony, paging, messaging, Internet and broadband data to mobile telecommunication devices. However, systems originally designed to provide UMTS services, such as the Internet Protocol (IP) Multimedia Subsystem (IMS), are now being used to provide NGN services to landline subscribers, as well. That is, there is a trend in the telecommunications industry to use a single network to support both wireless and wireline devices.

The fact that POTS telephones do not have the processing power needed to participate in NGNs presents LECs, and new telephone operating companies seeking to compete with LECs, with a quandary. Such entities may choose to maintain parallel networks to support NGN subscribers and POTS subscribers. Or, such entities may choose to implement only an NGN network and require their POTS subscribers to upgrade to soft phones, SIP phones, or other NGN-capable devices in order to continue receiving call functions such as Call Waiting, Call Hold and Call Transfer.

Therefore, there is a need in the art for an improved IMS. In particular, there is a need for an IMS that is capable of providing call functions to POTS telephone subscribers.

### SUMMARY OF THE INVENTION

A network, comprising various apparatus and methods, is described that is capable of providing call functions to POTS telephone subscribers. The IP Multimedia Subsystem (IMS) of the present disclosure allows a Local Exchange Carrier (LEC) providing Next Generation Network (NGN) services to provide those services to users of POTS telephones by coupling the POTS telephones to the IMS via a Session Initiation Protocol (SIP) Gateway. Furthermore, by not requiring the POTS telephone users to upgrade to SIP-capable devices, the IMS of the present disclosure allows both existing LECs and the POTS telephone users to reduce costs. Similarly, a new telephone operating company seeking to compete with existing LECs may implement a NGN and provide call functions to POTS subscribers using the IMS of the present disclosure.

Specifically, a SIP Gateway (SIPGW) coupled to an IMS detects that a first party, using a POTS telephone coupled to the SIPGW and participating in a call, has performed a hook flash action. In response to the detection, the SIPGW sends to the IMS a SIP INFO message indicating that the POTS telephone has performed the hook flash.

In response to a first SIP INFO message indicating that a first party, using a POTS telephone coupled to the SIPGW and participating in a call, has performed a first hook flash, an Application Server (AS) in an IMS places on hold a second party participating in the call. In response to a second SIP INFO message indicating that the first party has performed a second hook flash action, the AS may reestablish the call between the first party and the second party.

In further response to the first SIP INFO message, the AS may cause a Media Server (MS) to receive information from the first party identifying a call feature to be provided, where the call feature is simple call hold, consultation call hold, attended call transfer or unattended call transfer. Prior to the first SIP INFO message, the AS may indicate to the first party that a third party is calling the first party and, in response to the first SIP INFO message, the AS may place the second party on hold and establish a call between the first party and the third party.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network architecture according to an exemplary embodiment of the disclosure;

FIG. 2 is a flow diagram illustrating a method for providing Call Hold and Call Resume functions according to an exemplary embodiment of the disclosure;

FIGS. 3A-C are flow diagrams illustrating methods providing Consultation Call Hold, Attended Call Transfer and Unattended Call Transfer functions according to an exemplary embodiment of the disclosure; and

FIG. 4 is a flow diagram illustrating a method for providing a Call Waiting function according to an exemplary embodiment of the disclosure.

### DETAILED DESCRIPTION OF THE INVENTION

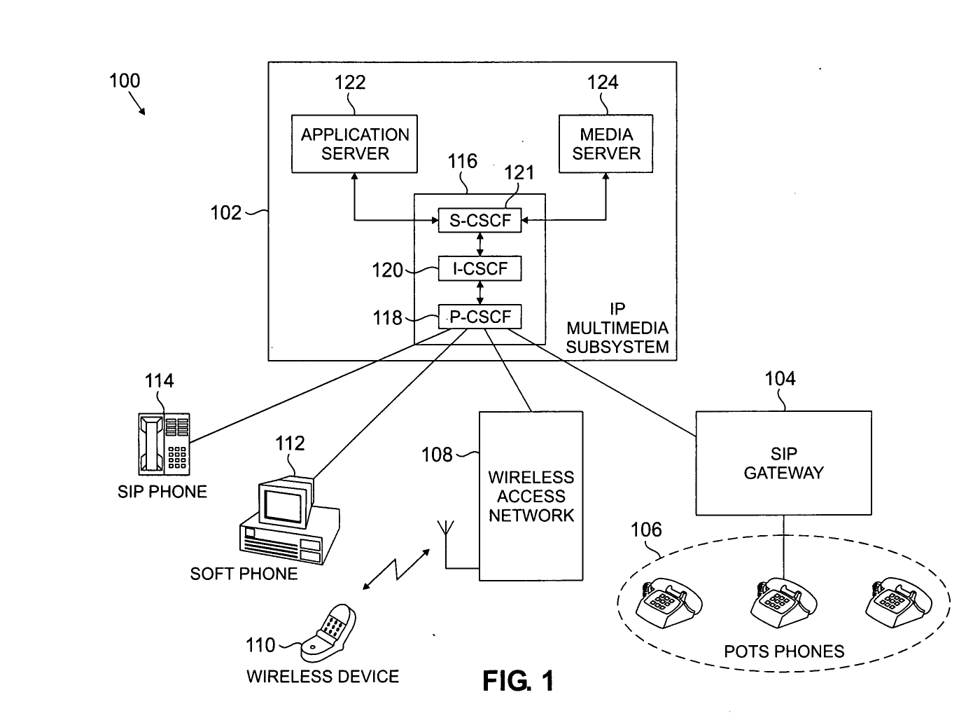

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged IP Multimedia Subsystem providing call features activated by Plain Ordinary Telephone Service telephones.

FIG. 1 illustrates an architecture of a network 100 according to an exemplary embodiment of the disclosure. An IP Multimedia Subsystem (IMS) 102 may be coupled to multiple devices communicating using the Session Initiation Protocol (SIP). One or more SIP gateways (SIPGW) 104 may be coupled to the IMS 102 and to one or more Plain Ordinary Telephone Service (POTS) telephones 106. One or more wireless access networks 108 may also be coupled to the IMS 102. The wireless access network 108 may be in communication with one or more wireless devices 110. One or more so-called “soft phones,” operating on computing devices 112 may be coupled with IMS 102, as may be one or more SIP phones 114. Furthermore, the IMS 102 may be coupled via a Wide Area Network or the Internet (not shown) to other such IMSs and/or SIP-capable communication devices.

The IMS 102 includes a Call Session Control Function (CSCF) 116, comprising a Proxy-CSCF 118 (P-SCSCF), an Interrogating-CSCF (I-CSCF) 120, and a Serving-CSCF (S-CSCF) 121. The IMS 102 also includes an Application Server (AS) 122 and a Media Server (MS) 124. The AS 122 and the MS 124 are coupled to the S-CSCF 121 and communicate with each other, and with the SIPGW 104, via the S-CSCF 121.

In general, activation of a call function from one of the POTS telephones 106 is initiated by a so-called “hook flash”—i.e., a brief depression of the hook or button on which the telephone handset rests when not in use. Alternatively, some POTS telephones have a “flash” button, which performs a hook flash action. The SIPGW 104 senses this hook flash and sends a SIP INFO message to the IMS 102. The SIP INFO message sent by the SIPGW 104 has the newly defined event type “Hookflash.” According to an embodiment of the present disclosure, the receipt of this SIP INFO message initiates processing in the IMS 102 to provide call functions such as Call Waiting, Call Hold and Call Transfer to the POTS telephones 106 coupled to the SIPGW 104. Of course, in another embodiment of the present disclosure, a different SIP message may be employed to provide call functions to the POTS telephones 106.

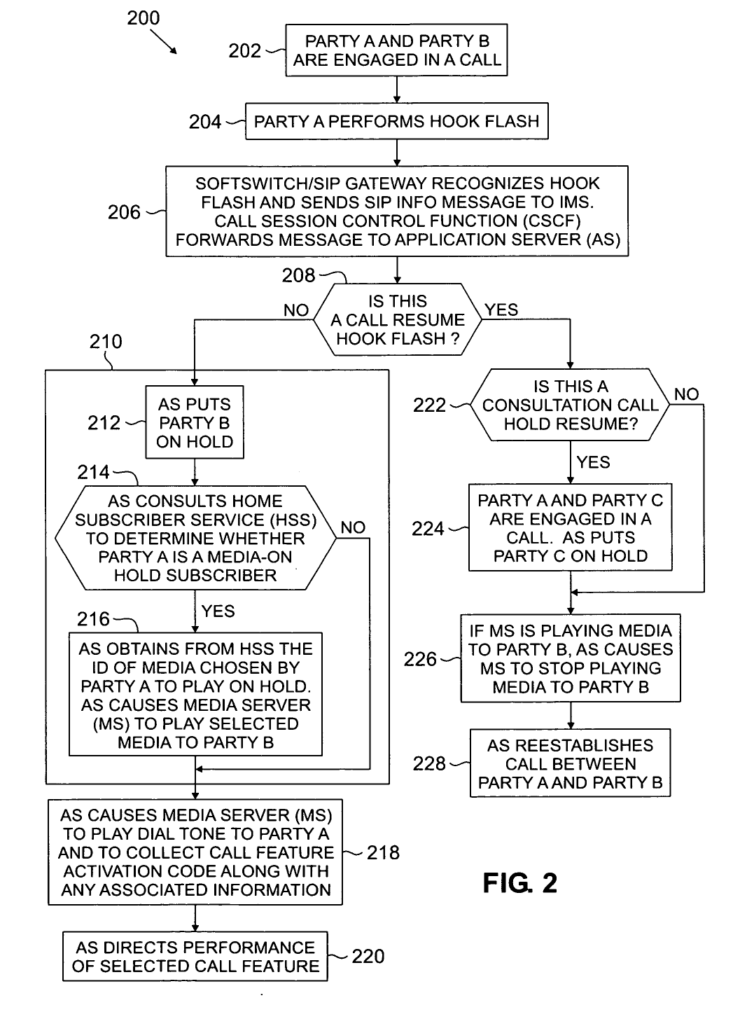

FIG. 2 illustrates initial steps 200 followed by IMS 102 in providing such call functions to the POTS telephones 106. At step 202 parties A and B are engaged in a call. Party A is using one of the POTS telephones 106, while party B may be any other user coupled to the network 100. In step 204 party A performs a hook flash action. The SIPGW 104 recognizes the action of POTS telephone 106 and sends a SIP INFO message having the event type Hookflash to the IMS 102. The CSCF 116 forwards the SIP INFO message to AS 122.

At step 208 the AS 122 determines whether this is a Call Resume hook flash action—i.e., whether party A had previously put another party on hold and is resuming the call to that party. If so, the process moves on to step 222, described below.

If the hook flash does not signal resumption of a call already on hold, then a sequence of steps 210 are performed. The sequence 210 begins with step 212 wherein the AS 122 puts party B on hold by sending a SIP REINVITE message. Where party B is using a POTS telephone 106, the REINVITE message is intercepted and handled by the SIPGW 104. In step 214 the AS 122 consults a Home Subscriber Service (HSS) (not shown in FIG. 1) for party A, to determine whether party A is a subscriber to a Media-on-Hold service. If not, the sequence 210 terminates.

If party A does subscribe to Media-on-Hold, however, in step 216 the AS 122 obtains from the HSS an ID of the media chosen by party A to be played on hold. The AS 122 then communicates the ID to MS 124 and causes the MS 124 to connect with party B and begin playing the selected media to party B. It will be understood that the media played by the MS 124 may be recorded music, recorded audio information or advertising, a broadcast radio signal, recorded video, or other media that party B is capable of receiving. The sequence 210 then terminates.

Once party B has been put on hold in the sequence 210, in step 218 the AS 122 causes the MS 124 to play a dial tone to party A and collect dialed digits that comprise a call feature activation code, along with any necessary associated information. The call feature code may indicate simple call hold, consultation call hold, attended call transfer or unattended call transfer. The simple call hold feature may be indicated by the absence of any further dialed digits. The MS 124 may use the same digit sequences used by the POTS subscriber's former Service Control Point in providing the same call functions, in order to prevent the POTS subscriber having to relearn how to obtain the call functions.

In the alternative, rather than playing a dial tone to party A, the MS 124 may play verbal instructions of the digit sequences used to activate the call features available to party A. The instructions may further be customized to list only the call features party A has subscribed to.

Once the MS 124 has collected any dialed digits, it communicates the selected call feature and any necessary associated information to the AS 122. The AS 122 then proceeds at step 220 to cause the selected call feature to be performed, as described later.

If the AS 122 determines at step 208 that the flash hook from party A signals the resumption of a call previously placed on hold, then at step 222 the AS 122 further determines whether it is the resumption of an ordinary call hold, or of a consultation call hold. In an ordinary call hold, party B is placed on hold while party A engages in some other activity. In a consultation call hold, party B is placed on hold while party A calls party C. Thus, if in step 222 the AS 122 determines that the current hook flash indicates that party A is in a consultation call with party C and wants to resume the call to party B, then in step 224 the AS 122 places party C on hold, using the sequence of steps 210.

Whether or not the present hook flash signaled the resumption of a consultation call hold, in step 226 the AS 122 determines whether the MS 124 is currently playing media to party B. If so, the AS 122 causes the MS 124 to stop playing the media. In step 228 the AS 122 then reestablishes the call between party A and party B.

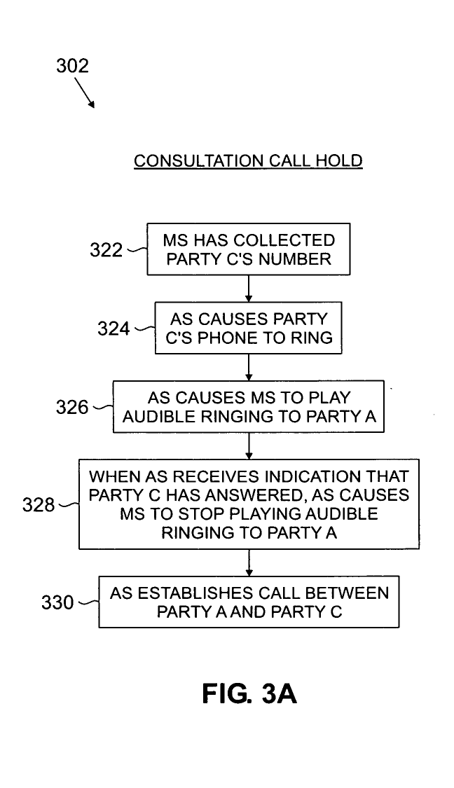

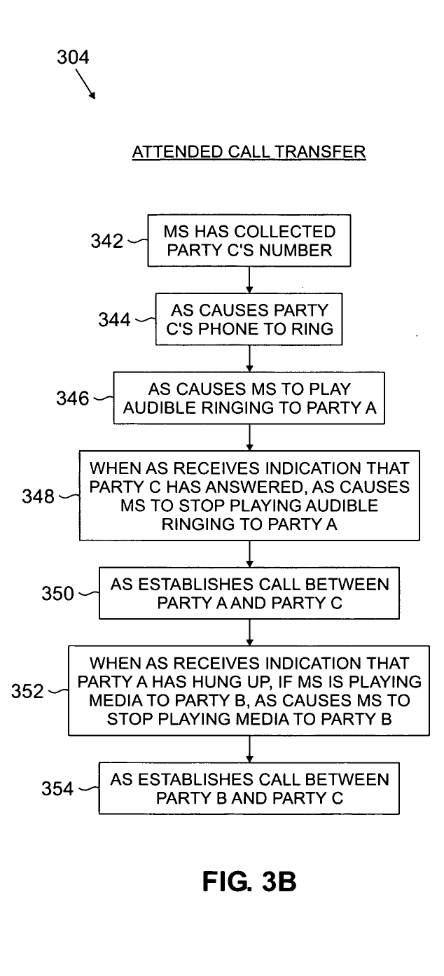

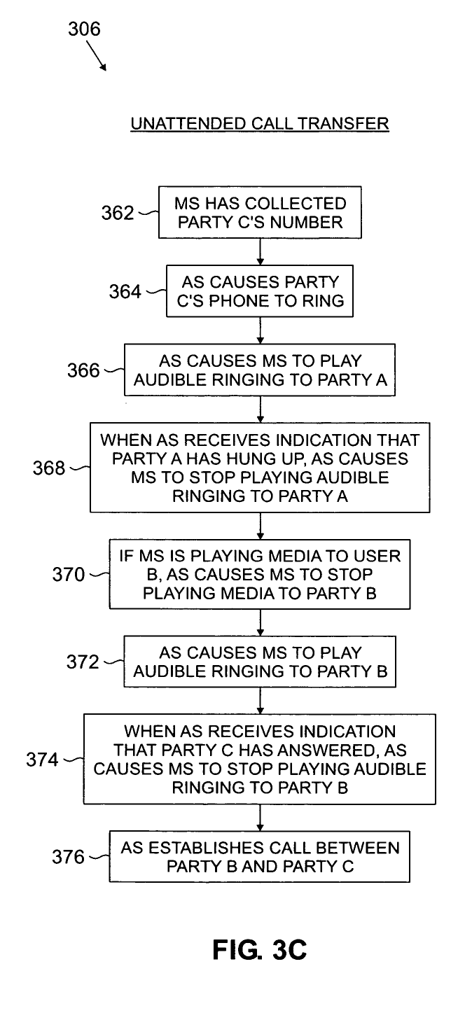

FIGS. 3A-C are flow diagrams illustrating methods providing Consultation Call Hold, Attended Call Transfer and Unattended Call Transfer functions according to an exemplary embodiment of the disclosure. These are the used to perform the selected call feature in step 220 of FIG. 2.

FIG. 3A illustrates a process 302 of establishing a consultation call hold, as defined in the description of step 222 of FIG. 2. The process 302 begins in step 322, where the MS 124 has collected party C's number, as associated information to the digits indicating that the selected call feature is a consultation call hold. As described with regard to step 218 of FIG. 2, the MS 124 communicates party C's number to the AS 122. In step 324 the AS 122 sends a SIP INVITE message to party C, causing a SIP-capable party C to begin ringing and to respond to AS 122 with a SIP 180 RINGING message. Where party C is using a POTS telephone 106, the SIPGW 104 intercepts the INVITE message, causes party C's POTS telephone 106 to ring, and responds to the AS 122 with the 180 RINGING message. In step 326, the AS 122 also causes the MS 124 to play an audible ringing announcement to party A.

When the AS 122 receives an indication that party C has answered (either directly from a SIP-capable device or from the SIPGW 104 supporting a POTS telephone 106), in step 328 the AS 122 causes the MS 124 to stop playing the audible ringing announcement to party A. In step 330 the AS 122 then establishes the call between party A and party C.

FIG. 3B shows the process 304 of performing an attended call transfer, wherein party A puts party B on hold, speaks to party C and then hangs up, causing party B to be transferred to party C. The process begins in step 342, where the MS 124 has collected party C's number and communicated it to the AS 122. In step 344 the AS 122 causes party C's phone (or other device) to ring, as described with regard to step 324 of consultation call hold process 302. In step 346 the AS 122 also causes the MS 124 to play an audible ringing announcement to party A. In step 348, when the AS 122 receives an indication that party C has answered, as described with regard to step 328 of consultation call hold process 302, the AS 122 causes the MS 124 to stop playing the audible ringing announcement to party A.

In step 350 the AS 122 then establishes a call between party A and party C. After some period of time, the AS 122 receives an indication from the SIPGW 104 that party A using POTS telephone 106 has hung up, in step 352. The AS 122 then determines whether the MS 124 has been playing media to party B while on hold and, if so, the AS 122 causes the MS 124 to stop playing media to party B. Finally, in step 354 the AS establishes a call between party B and party C.

FIG. 3C illustrates a process 306 providing an unattended call transfer feature. In an unattended call transfer, party A puts party B on hold, calls party C and, upon hearing a ringback indicating that party C's phone is ringing, hangs up. Party B then hears the ringback until party C answers. In step 362, the MS 124 has collected party C's number and communicated it to the AS 122. As described with regard to step 324 of consultation call hold process 302, in step 364 the AS causes party C's phone (or other device) to ring. In step 366 the AS 122 causes the MS 124 to play an audible ringing announcement to party A. Step 368 begins when the AS 122 receives a SIP BYE message from the SIPGW 104 supporting party A's POTS telephone 106, the SIP BYE message indicating that party A has hung up. Step 368 continues with the AS 122 causing the MS 124 to cease playing the audible ringing announcement to party A.

In step 370 the AS 122 determines whether the MS 124 is playing media to party B and, if so, the AS 122 causes the MS 124 to stop playing the media to party B. Then, in step 372 the AS 122 causes the MS 124 to begin playing an audible ringing announcement to party B. In step 374, when the AS 122 receives an indication that party C has answered, as described with regard to step 328 of consultation call hold process 302, the AS 122 causes the MS 124 to stop playing the audible ringing announcement to party B. Finally, in step 376 the AS 122 establishes a call between party B and party C.

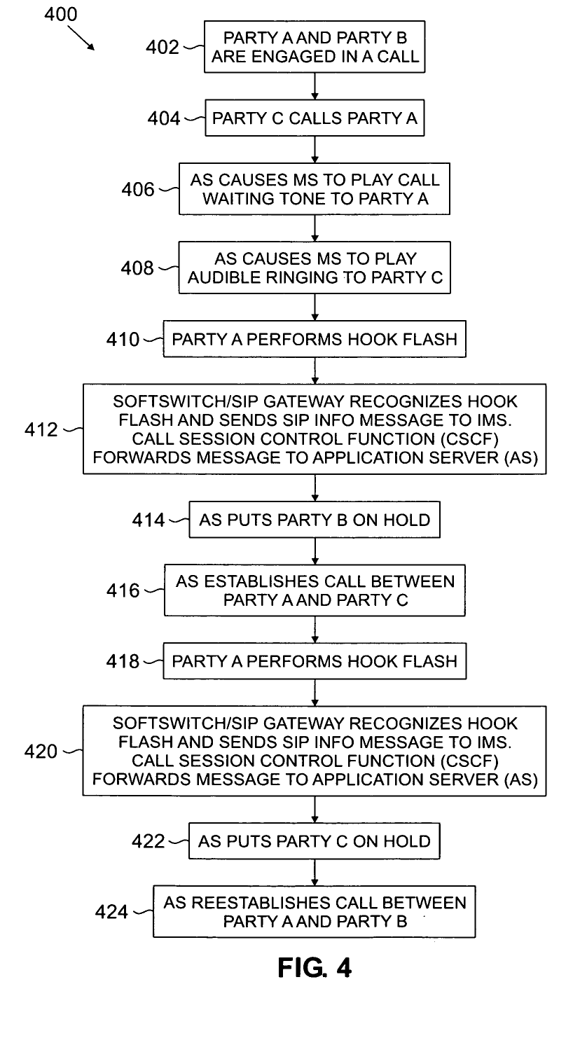

FIG. 4 is a flow diagram illustrating a method for providing a Call Waiting function according to an exemplary embodiment of the disclosure. In step 402, party A and party B are engaged in a call. As described with regard to FIG. 2, party A is using one of the POTS telephones 106, while party B may be any other user coupled to the network 100. In step 404, the AS 122 receives a SIP INVITE message indicating that party C is calling party A. Like party B, party C may be any other user coupled to the network 100.

In response to the SIP INVITE message, in step 406 the AS 122 causes the MS 124 to play a call waiting announcement to party A. It will be understood that the call waiting announcement played by the MS 124 may be a standard call waiting tone, a ring tone chosen according to the identity of party C, an announcement verbally identifying party C (e.g., “Joe Smith is calling you”), or other call waiting announcement chosen by party A. In the alternative, the AS 122 may cause the SIPGW 104 to play a call waiting tone to party A. In step 408 the AS 122 also causes the MS 124 to play an audible ringing announcement to party C.

In response to the call waiting tone, party A performs a hook flash action on POTS telephone 106 in step 410. In step 412, the hook flash is recognized by the SIPGW 104, which sends a SIP INFO message with event type Hookflash to the IMS 102. The CSCF 116 forwards the SIP INFO message to the AS 122.

In response to the SIP INFO message, in step 414 the AS 122 puts party B on hold, using the sequence of steps 210. The AS 122 then establishes a call between party A and party C in step 416. After some period of time, in step 418 party A performs a hook flash, indicating a desire to put party C on hold and resume the call to party B. In step 420 the SIPGW 104 recognizes the hook flash and again sends a SIP INFO message with event type Hookflash to the IMS 102. The CSCF 116 again forwards the SIP INFO message to the AS 122. In step 422 the AS 122 puts party C on hold, again using the sequence of steps 210 from FIG. 2. Finally, in step 424 the AS 122 reestablishes the call between party A and party B.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in an IP Multimedia Subsystem (IMS), a method of providing call hold service to Plain Ordinary Telephone Service (POTS) telephones coupled to the IMS via a SIP Gateway (SIPGW), comprising the steps of:
receiving a first SIP INFO message sent by the SIPGW, the first message indicating that a first party participating in a call has performed a first hook flash, wherein the first party is using a POTS telephone coupled to the SIPGW; and
in response to the first message, placing on hold a second party participating in the call.

2. The method as set forth in claim 1, further comprising:
receiving a second SIP INFO message sent by the SIPGW, the second message indicating that the first party has performed a second hook flash; and
in response to the second message, reestablishing the call between the first party and the second party.

3. The method as set forth in claim 1, wherein the step of placing on hold a second POTS phone further comprises playing media to the second party.

4. The method as set forth in claim 1, further comprising, in response to the first message, receiving information from the first party, the information identifying a call feature to be provided.

5. The method as set forth in claim 4, wherein the call feature to be provided is one of simple call hold, consultation call hold, attended call transfer and unattended call transfer.

6. The method as set forth in claim 1, further comprising:
in response to the first message, receiving information from the first party, the information identifying a third party; and
establishing a call between the first party and the third party.

7. The method as set forth in claim 6, further comprising:
receiving a second SIP INFO message sent by the SIPGW, the second message indicating that the first party has performed a second hook flash; and
in response to the second message, placing on hold the third party and reestablishing the call between the first party and the second party.

8. The method as set forth in claim 1, further comprising:
in response to the first message, receiving information from the first party, the information identifying a third party; and
establishing a call between the second party and the third party.

9. The method as set forth in claim 1, further comprising:
indicating to the first party that a third party is attempting to establish a call to the first party; and
in response to the first message, establishing a call between the first party and the third party.

10. The method as set forth in claim 9, further comprising:
receiving a second SIP INFO message sent by the SIPGW, the second message indicating that the first party has performed a second hook flash; and
in response to the second message, placing on hold the third party and reestablishing the call between the first party and the second party.

11. An IP Multimedia Subsystem (IMS), capable of providing call hold service to Plain Ordinary Telephone Service (POTS) telephones coupled to the IMS via a SIP Gateway (SIPGW), the IMS comprising an Application Server (AS) capable of:
receiving a first SIP INFO message sent by the SIPGW, the first message indicating that a first party participating in a call has performed a first hook flash, wherein the first party is using a POTS telephone coupled to the SIPGW; and
in response to the first message, placing on hold a second party participating in the call.

12. The IP Multimedia Subsystem as set forth in claim 11, wherein the AS is further capable of:
receiving a second SIP INFO message sent by the SIPGW, the second message indicating that the first party has performed a second hook flash; and
in response to the second message, reestablishing the call between the first party and the second party.

13. The IP Multimedia Subsystem as set forth in claim 11, further comprising a Media Server (MS), wherein the AS is further capable of causing the MS to play media to the second party.

14. The IP Multimedia Subsystem as set forth in claim 11, further comprising a Media Server (MS), wherein the AS is further capable of causing the MS to receive information from the first party, the information identifying a call feature to be provided.

15. The method as set forth in claim 14, wherein the call feature to be provided is one of simple call hold, consultation call hold, attended call transfer and unattended call transfer.

16. The IP Multimedia Subsystem as set forth in claim 11, further comprising a Media Server (MS), wherein the AS is further capable of:
causing the MS to receive information from the first party, the information identifying a third party; and
establishing a call between the first party and the third party.

17. The IP Multimedia Subsystem as set forth in claim 16, wherein the AS is further capable of:
receiving a second SIP INFO message sent by the SIPGW, the second message indicating that the first party has performed a second hook flash; and
in response to the second message, placing on hold the third POTS telephone and reestablishing the call between the first party and the second party.

18. The IP Multimedia Subsystem as set forth in claim 11, further comprising a Media Server (MS), wherein the AS is further capable of:
causing the MS to receive information from the first party, the information identifying a third party; and
establishing a call between the second party and the third party.

19. The IP Multimedia Subsystem as set forth in claim 11, further wherein the AS is further capable of:
indicating to the first party that a third party is attempting to establish a call to the first party; and
in response to the first message, establishing a call between the first party and the third party.

20. The method as set forth in claim 19, further comprising:
receiving a second SIP INFO message sent by the SIPGW, the second message indicating that the first party has performed a second hook flash; and
in response to the second message, placing on hold the third party and reestablishing the call between the first party and the second party.

21. For use in a SIP Gateway (SIPGW) coupled to an IP Multimedia Subsystem (IMS), a method of providing call hold service to Plain Ordinary Telephone Service (POTS) telephones coupled to the SIPGW, comprising the steps of:
detecting that a party participating in a call has performed a first hook flash, wherein the party is using one of the POTS telephones coupled to the SIPGW; and
in response to the detection, sending to the IMS a SIP INFO message indicating that the party has performed the hook flash.

22. A SIP Gateway (SIPGW) coupled to an IP Multimedia Subsystem (IMS) capable of providing call hold service to Plain Ordinary Telephone Service (POTS) telephones coupled to the SIPGW, the SIPGW capable of:
detecting that a party participating in a call has performed a first hook flash, wherein the party is using one of the POTS telephones coupled to the SIPGW; and
in response to the detection, sending to the IMS a SIP INFO message indicating that the party has performed the hook flash.
